(19) United States
(12) Patent Application Publication
(10) Pub. No.: US 2005/0210503 A1
(43) Pub. Date: Sep. 22, 2005

(54) Remote control unit guide display

(75) Inventor: Yoshiyuki Tsuji, Takefu-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 11/066,179

(22) Filed: Feb. 25, 2005

(30) Foreign Application Priority Data
Mar. 18, 2004 (JP) 2004-078887

(51) Int. Cl. H04N 7/173; H04N 5/44; G06F 13/00; G11B 27/00

(52) U.S. Cl. 725/37; 715/716; 348/734

(57) ABSTRACT

This invention is intended to facilitate a setting operation using a remote control unit without increasing a manufacturing cost of an audiovisual (AV) apparatus. The AV apparatus includes means for displaying a keypad pattern of the remote control unit used for a setting operation for the AV apparatus, on a setting screen.

### BACKGROUND OF THE INVENTION

1. Field of the Invention

The present invention relates to an audiovisual apparatus. More specifically, the present invention relates to an audiovisual apparatus including a display monitor and a remote control unit.

2. Description of the Related Art

Conventionally, an audiovisual apparatus (hereinafter, “AV apparatus”), e.g., a television receiver can display a user setting screen. On this user setting screen, a user can set various conditions such as those for a video, a voice, a channel and the like of the television receiver using a remote control unit so as to optimally match to a user's utilization state of the television receiver.

If the number of setting types increases, the user needs to make many settings using one remote control unit. A setting operation is sometimes, therefore, not easy for the user to perform.

To facilitate the setting operation using the remote control unit, Patent Literature 1 proposes a technique intended to provide guide means for informing the user of a key operation in the remote control unit. With this proposed technique, however, the AV apparatus is required to include means for holding a two-way communication with the remote control unit. As a result, it is disadvantageously necessary to include additional hardware in the AV apparatus and a manufacturing cost of the AV apparatus is disadvantageously increased.

Patent Literature 1: Japanese Patent Application Laid-Open No. 2003-143435

### SUMMARY OF THE INVENTION

It is an object of the present invention to facilitate a setting operation using a remote control unit without increasing a manufacturing cost of an AV apparatus.

To attain the object, according to the present invention, there is provided an audiovisual apparatus including a display monitor and a remote control unit, and comprising: means for displaying a setting screen, on which a user performs a setting operation for the audiovisual apparatus using the remote control unit, on the display monitor; and means for displaying a keypad pattern of the remote control unit used for the setting operation for the audiovisual apparatus, on the setting screen. Further, to attain this object, there is also provided an audiovisual apparatus further comprising means for displaying a key used for the setting operation for the audiovisual apparatus, on the displayed keypad while marking the key.

These means provided by the present invention enable the user to be given guidance to recognize which key of the remote control unit is to be used on the setting screen for optimally setting parameters for the AV apparatus. It is, therefore, possible to facilitate the setting operation.

### BRIEF DESCRIPTION OF THE DRAWINGS

FIG. 1 is a block diagram that depicts one embodiment of the present invention;

FIG. 2 is a typical view that depicts a keypad of a remote control unit according to the embodiment of the present invention;

FIG. 3 is a typical view that depicts a display monitor for displaying a setting screen made according to the embodiment of the present invention;

FIG. 4 is a typical view that depicts a setting screen made according to the embodiment of the present invention;

FIG. 5 is a typical view that depicts another setting screen made according to the embodiment of the present invention; and

FIG. 6 is a typical view that depicts yet another setting screen made according to the embodiment of the present invention.

### DESCRIPTION OF THE PREFERRED EMBODIMENT

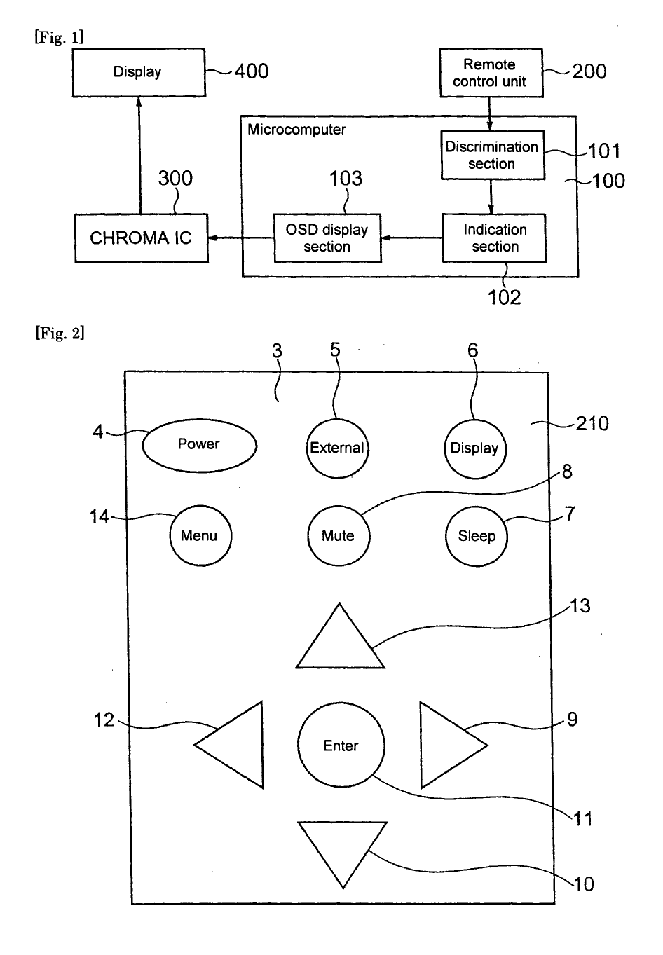

An embodiment of the present invention will be described hereinafter with reference to the drawings. As shown in the block diagram of FIG. 1, an AV apparatus according to the embodiment of the present invention includes a display monitor 400, a remote control unit 200, a video signal processing integrated circuit (Chroma IC) 300 for displaying a setting screen, on which a user can make various settings of the AV apparatus, on the display monitor 400, and a microcomputer 100 including an ON screen display (“OSD”) display section 103 that controls the video signal processing IC 300 to display the setting screen. The microcomputer 100 also includes a discrimination section 101 that discriminates a signal from the remote control unit 200, and an indication section 102 that controls the OSD display section 103, whereby the user can make the settings of the AV apparatus on the setting screen using the remote control unit 200.

The remote control unit 200 includes a keypad 210 having a key layout shown in FIG. 2. On the key layout of this keypad 210, a power button 4, an external connection button 5, a display button 6, a sleep key 7, a mute key 8, move up, down, right, and left keys 13, 10, 9, and 12, a menu key 14, and an Enter key 11 are arranged.

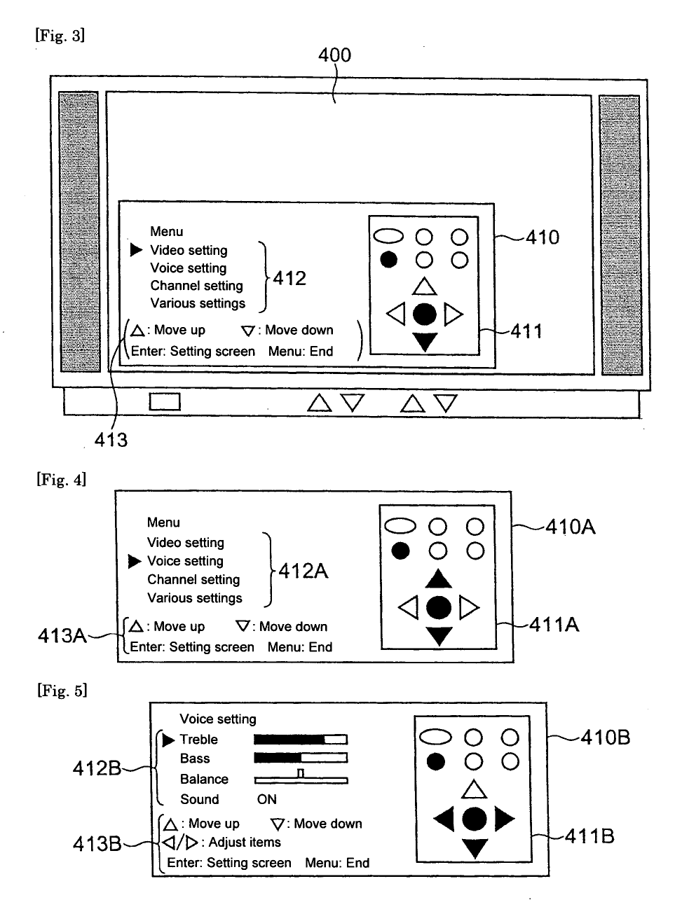

The microcomputer 100 shown in FIG. 1 is programmed to display a setting screen 410 (410A, 410B, or 410C) on which the user performs a setting operation for this AV apparatus onto a display monitor 400 using the remote control unit 200. On this setting screen 410 (410A, 410B, or 410C), a choice display section 412 (412A, 412B, or 412C) that displays choices for the settings, a guide section 413 (413A, 413B, or 413C) that gives the user guidance in how to make choices, and a keypad pattern 411 (411A, 411B, or 411C) of the remote control unit 200 are displayed. In FIG. 3, this setting screen 410 is displayed as a child screen arranged in a partial portion of the display monitor 400. Needless to say, the setting screen 410 can be displayed entirely on the display monitor 400.

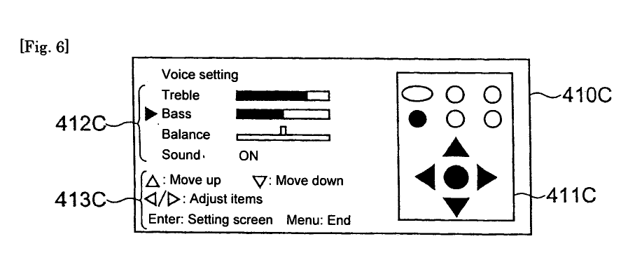

When the user depresses the menu key 14 of the remote control unit 200 at a certain time, the setting screen 410 shown in FIG. 3, for example, is displayed. On the setting screen 410, the user can select a setting type in the choice display section 412. The guidance for the selection is displayed in the guide section 413. Namely, after moving a cursor onto a desired setting type by the move up key 13 and the move down key 10, the user depresses the Enter key 11 to recognize that the setting type is selected. At this time, in the keypad pattern 411 of the remote control unit 200 displayed in parallel with displays of these sections 412 and 413, keys that are available for the user's selection according to the guidance displayed in the guide section 413 are selectively displayed while being marked and highlighted. In FIGS. 3 to 6, the available keys are displayed in black. Namely, the available keys are displayed in a color different from a color of unavailable keys or at a brightness which enables the user to discriminate the available keys from the unavailable keys. Alternatively, only the available keys may be flashing the light on and off.

When the user then depresses the move down key 10 of the remote control unit 200 once, the setting screen 410A for selecting a “voice setting” shown in FIG. 4 is displayed. In the keypad pattern 411A on this setting screen 410A, the move up key 13 which is not marked in the keypad pattern 411 of the previous setting screen 410 is marked. This is because this setting screen 410A enables the user to move the cursor onto a “video setting” displayed on an upper position and to select the “video setting” using the move up key 13.

When the user then depresses the Enter key 11, the setting screen 410B for the “voice setting” shown in FIG. 5 is displayed. On this setting screen 410B, the user can make settings such as treble, bass, balance, on or off settings of sound in the choice display section 412B. Remote control unit usage guidance in making these settings is displayed in the guide section 413B, and available keys of the remote control unit 200 are displayed while being marked in the keypad pattern 411B. On the setting screen 410B on which the treble setting is selected, a volume of the treble can be selected by the move left and move right keys 12 and 9.

When the user then depresses the move down key 10 and selects the bass setting, the setting screen 410C is displayed. On this setting screen 410C, voice setting items are displayed in the choice display section 412C, remote control unit keys available for making the settings are guided by characters in the guide section 413C, and the remote control unit keys available on the setting screen 410C are displayed while being marked in the keypad pattern 411C.

On each of these displayed setting screens according to the embodiment of the present invention, the keypad pattern 411 (411A, 411B, or 411C) of the remote control unit 200, in which available remote control unit keys are displayed while being marked, is displayed. Therefore, the present invention has an industrial adaptability that the AV apparatus facilitating user's executing the AV apparatus setting operation can be obtained.

1. An audiovisual apparatus including a display monitor and a remote control unit, comprising:
means for displaying a setting screen, on which a user performs a setting operation for the audiovisual apparatus using the remote control unit, on the display monitor; and
means for displaying a keypad pattern of the remote control unit used for the setting operation for the audiovisual apparatus, on the setting screen.

2. The audiovisual apparatus according to claim 1, further comprising means for displaying a key used for the setting operation for the audiovisual apparatus, on the displayed keypad while marking the key.
